(19) United States
(12) Patent Application Publication
(10) Pub. No.: US 2005/0249338 A1
(43) Pub. Date: Nov. 10, 2005

(54) Method and telecommunications system for processing digitally stored sound sequences

(75) Inventors: Oliver Brasse, Witten (DE); Stephan Schuler, Witten (DE)

Correspondence Address: Siemens Corporation;Intellectual Property Department, 170 Wood Avenue South, Iselin, NJ, 08830, US

(73) Assignee: Siemens Aktiengesellschaft, Muenchen (DE)

(21) Appl. No.: 10/528,730

(22) PCT Filed: Aug. 7, 2003
(86) PCT No.: PCT/DE03/02661

§ 371 Date: Mar. 22, 2005

(30) Foreign Application Priority Data
Sep. 27, 2002 (DE) 102 45 232.6

(51) Int. Cl. H04M 11/00; H04M 3/42

(52) U.S. Cl. 379/88.16; 379/93.01; 379/215.01

(57) ABSTRACT

The invention relates to a method for processing digitally stored sound sequences, such as holding music MOH (Music on Hold), voice sequences or signal tones, in a telecommunications system equipped with a CPU, a working memory for the CPU, and with a switching network. A program code and/or data of telecommunications subscribers is/are preferably stored in the working memory. The telecommunications system establishes connections to terminals via the switching network and outputs sound sequences via the switching network to at least one telecommunications terminal. The invention also relates to a telecommunications system that is equipped with means for carrying out said method. Both the novel method as well as the telecommunications system are characterized in that at least one portion of the working memory, which is assigned to the CPU, is used for storing the digitally stored sound sequences.

### CROSS REFERENCE TO RELATED APPLICATIONS

This application is the US National Stage of International Application No. PCT/DE2003/002661, filed Aug. 7, 2003 and claims the benefit thereof. The International Application claims the benefits of German application No. 10245232.6 filed Sep. 27, 2002, both applications are incorporated by reference herein in their entirety.

### FIELD OF THE INVENTION

The invention relates to a method for handling digitally stored sound sequences, such as holding music (=MOH=Music on Hold), voice sequences or signal tones, in a telecommunications system having a CPU, a working memory for the CPU, and a switching network, wherein a program code and/or data of telecommunications subscribers is/are preferably stored in a working memory, the telecommunications system establishes connections to terminals via the switching network and outputs sound sequences via the switching network to at least one telecommunications terminal. The invention also relates to a telecommunications system that is equipped with means for performing the method.

### BACKGROUND OF THE INVENTION

In modern telecommunications systems such as, for example, the telecom application PBX (=Private Branch Exchange) data is increasingly exchanged in the form of voice, MOH (Music on Hold) and sounds, both in the case of the traditional PBX and in the case of the internet-based PBX. In this scenario announcement texts, MOH and sounds that are stored on an additional storage medium such as a tape or a CD, for example, are retrieved by a telecommunications subscriber. Previously this data was mostly fed into the telecommunications system by means of additional hardware components such as, for example, a DSP (Digital Signal Processor) connected to a PCM switch. In order to generate special sounds such as, for example, the conference tone in the direction of an exchange, a tone generator chip or also SIU (=Signaling Unit) is required. These additional hardware components are very costly, as a result of which the telecommunications system as a whole becomes unnecessarily expensive.

### SUMMARY OF THE INVENTION

It is therefore the object of the invention to provide a method which enables sound sequences such as, for example, holding music (=MOH=Music on Hold), voice sequences or signal tones to be handled in a telecommunications system in such a way that there is no necessity—as previously—to employ additional and costly hardware components such as, for example, an SIU (Signaling Unit), a DSP (=Digital Signal Processor) or an AD/DA converter.

This object is achieved by the claims. Advantageous embodiments of the invention are the subject matter of dependent claims.

The inventors have recognized that in an existing telecommunications system such as the PBX, for example, the resources of certain hardware components such as controllers, CPU or working memory of the CPU are not always fully utilized. The inventors have also recognized that it is possible by means of a new method to use these existing hardware components in a telecommunications system in such a way that they can record and output holding music (=MOH=Music on Hold), voice sequences or signal tones. By this means it is possible to save on additional hardware for storing or inserting sound sequences.

Accordingly the inventors propose improving the method for handling digitally stored sound sequences such as holding music (=MOH=Music on Hold), voice sequences or signal tones, in a telecommunications system having a CPU, a working memory for the CPU, and a switching network, wherein a program code and/or data of telecommunications subscribers is/are preferably stored in the working memory, the telecommunications system establishes connections to terminals via the switching network and outputs sound sequences via the switching network to at least one telecommunications terminal, such that at least a part of the working memory is used for storing the digitally stored sound sequences.

As the working memory is already an existing hardware component of the telecommunications system and is also suitable for storing digitally stored sound sequences, the hardware components previously used for storing and inserting digitally stored sound sequences can thereby be saved. The inventors have taken into account that the size of the existing working memory can be adjusted in terms of its capacity to allow for the digitally stored sound sequences that are to be stored in addition.

It is beneficial if the CPU performs a data transfer of the digitally stored sound sequences between working memory and switching network. The CPU has a particularly short access time to the assigned working memory, thereby allowing a particularly fast data transfer.

It is also very advantageous if the data is transferred serially in packets and a TSA (=Timeslot Assigner) is used between working memory and switching network in order to assign the digitally stored sound sequences to programmed timeslots. A timeslot assigner is a module used for assigning data to programmed time intervals (=timeslots). In a telecommunications system the data exchange is variable and irregular dependent upon the utilization of the telecommunications system's capacity. In this case the packet-by-packet data transfer is more efficient compared to a data transmission based on a fixed clock cycle.

In order to support the packet-by-packet data transfer it is particularly beneficial to use a FIFO shift register in the timeslot assigner, which shift register buffers the digitally stored sound sequences prior to their being forwarded. The function of the FIFO shift register is very similar to that in the case of a holding loop. The data does not travel at a fixed rate from the input of the FIFO shift register to the output, but is held in the register until all the preceding data has been output. Thanks to the use of the FIFO shift register in the new method the load on the CPU can be relieved when the CPU is being utilized by the telecommunications system. The size of the FIFO shift register also influences the interrupt frequency. The bigger the FIFO shift register, the fewer interrupt commands are sent to the CPU. By this means the CPU load is reduced further.

It is also beneficial if at least one microcontroller, in particular a DMA controller, is used between working memory and TSA. The microcontroller can be initialized by the CPU to perform a transfer of the digitally stored sound sequences. Since the microcontroller, which can also be a PEC controller, takes charge of the data transport function, the CPU is relieved of the processing load for the transport tasks.

When the PEC controller is used, the data is transferred on an event-driven basis (PEC transfer) and a TSA is used between working memory and switching network in order to assign the digitally stored sound sequences to programmed timeslots. In the case the event-driven data transfer is more efficient compared to a data transmission at a fixed rate, since actions on the part of the PEC controller are necessary only when an event occurs, in this case the frame synchronization signal of the timeslot assigner.

It is furthermore beneficial if the CPU requests the microcontroller to set the start address of the digitally stored sound sequences in the working memory and the destination address in the FIFO shift register of the TSA or, in the case of the PEC transfer, to set the address of the transmit timeslot as the destination address in order to play back the digitally stored sound sequences. In order to record sound sequences it is beneficial if the CPU requests the microcontroller to set the start address of the digitally stored sound sequences in the FIFO shift register or, in the case of the PEC transfer, to set the address of the receive timeslot in the TSA and the destination address in the working memory. Since the controller also handles the transport of the digitally stored sound sequences in addition to the transport of the telecommunications data of the telecommunications system, the hardware utilization and the efficiency of the existing telecommunications system are improved.

In the past, additional hardware components such as, for example, a digital signal processor were required in order to digitize or insert sound sequences into a telecommunications system. Said digital signal processor performs a number of tasks, including that of AD conversion.

In accordance with the underlying inventive idea the inventors also propose that in the new method the telecommunications system itself digitizes the sound sequences and stores them in the working memory. Since the existing hardware components of the telecommunications system are also suitable for performing this digitization, hardware components such as digital signal processor, AD/DA converter and signaling unit can be saved by means of the new method.

It can be advantageous with the method using the DMA controller if, at a certain filling level of the FIFO shift register, the timeslot assigner requests the CPU by means of an interrupt command to start or to stop a new data transfer. This ensures that the fall-through time through the FIFO shift register is kept to a minimum. With a full FIFO shift register this also prevents data that has not yet been read out from being overwritten. With an empty FIFO shift register this avoids old data being output a second time. The inventors propose that an interrupt command be issued when a FIFO shift register is half full.

In the new method for handling digitally stored sound sequences in a telecommunications system it is beneficial if, instead of the DMA controller, a CPU with integrated PEC (=Peripheral Event Control) transfer controller, for example a C166 controller (e.g. Infineon C165Utah or C161U), is used for the transfer of the sound sequences between working memory and TSA. The PEC controller is a special implementation of a DMA controller within the C166 microcontroller family.

The PEC transfer feature is particularly advantageous because it offloads the CPU during the transfer of the sound sequences.

It is also particularly advantageous if an existing telecommunications system is equipped with means, preferably with program means or with program modules, which enable the above-described method to be performed. By these means it is made possible for digitally stored sound sequences to be transferred and stored in a telecommunications system without the need for the previously used additional hardware components. Such program means can also be stored in the existing working memory or in a module of the telecommunications system.

Additional features and advantages of the invention will be apparent from the following description of preferred exemplary embodiments with reference to the drawings.

### BRIEF DESCRIPTION OF THE DRAWINGS

The invention will be explained in more detail below with reference to the drawings, in which:

FIG. 1: is a schematic representation of a known telecommunications system;

FIG. 2: is a schematic representation of the new transmission method of digitally stored sound sequences in a telecommunications system;

FIG. 3: is a schematic representation of the new method for transmitting digitally stored sound sequences in a telecommunications system, supported by a DMA controller or PEC controller.

### DETAILED DESCRIPTION OF THE INVENTION

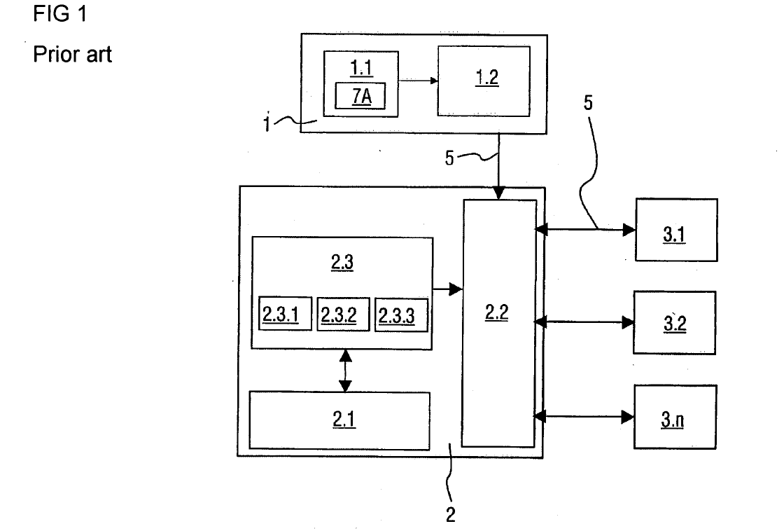

FIG. 1 shows in a schematic representation the hardware components of a telecommunications system known from the prior art. The PBX telecommunications system 2 consists of a microcontroller 2.3 which has a CPU 2.3.1, a DMA access 2.3.2 to the working memory 2.1 and a timeslot assigner 2.3.3 having a FIFO shift register. Data of the telecommunications subscribers such as customer numbers and the program code of the PBX telecommunications system 2 are stored in the working memory 2.1. With the aid of a PCM switch 2.2 all terminals 3.1 to 3.n of the telecommunications subscribers are connected to the PBX telecommunications system 2. Such a PBX telecommunications system 2 can be part of a call center, for example. If announcement texts or Music on Hold are now to be transmitted to the telecommunications subscribers who are for example held in a holding loop, additional hardware components are required for this purpose.

An additional hardware component of this kind is the external MOH module 1, which in this case contains an analog sound source 1.1 and a digital signal processor 1.2. The announcement text or Music on Hold is stored on the analog sound source 1.1. The analog data is digitized by means of the digital signal processor 1.2, which performs an AD/DA conversion. The digitized announcement texts or Music on Hold are connected to the terminals 3.1 to 3.n of the telecommunications subscribers via the PCM switch 2.2. If announcement texts or MOH are now to be recorded, they are routed to the digital signal processor 1.2 via the PCM switch 2.2. The digital signal processor 1.2 converts the announcement texts or MOH and stores them on the analog sound source 1.1.

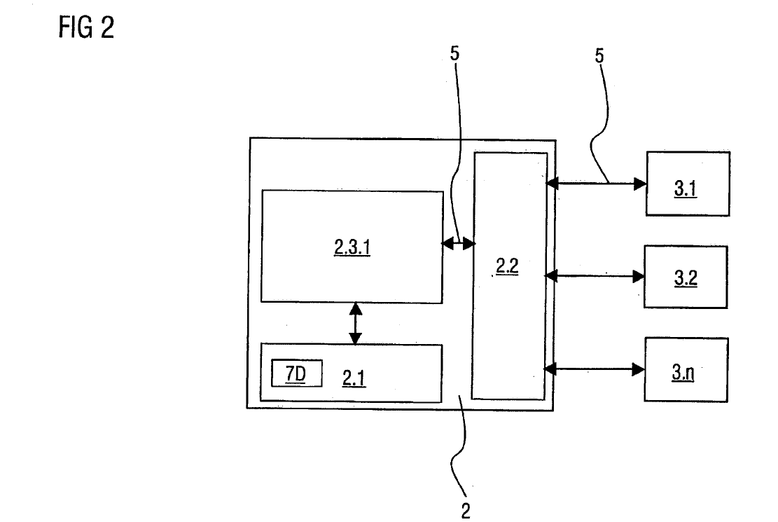

The object of the invention is to save on this additional hardware component, which also represents an additional cost outlay. FIG. 2 shows that the storing of sound sequences, which formerly took place in a storage medium, in the EPROM for example, in an external MOH module, can now be handled by the existing working memory.

FIG. 2 shows a schematic representation of the new transmission method of digitally stored sound sequences in a telecommunications system. The sound sequences 7D are now digitally stored in the working memory 2.1 of the CPU 2.3.1 in addition to the program code of the telecommunications system. The size of the working memory 2.1 is adjusted according to the size of the digital sound sequences 7D to be stored. The CPU 2.3.1 has a direct access to the working memory 2.1 and hence also to the digitally stored sound sequences 7D. The terminals 3.1 to 3.n of the telecommunications subscribers are connected to the CPU 2.3.1 via a PCM (Pulse Code Modulation) switch 2.2.

If, for example, a voice announcement is now to be output to a subscriber, the CPU 2.3.1 accesses the relevant announcement text in the working memory 2.1 and transmits it to said subscriber via the PCM switch 2.2. With the new method there is also the possibility that the telecommunications subscribers can record music and/or voice texts, for example, via their terminals 3.1 to 3.n. In this way a voice message transmitted via the telephone can be stored in pulse code modulated form in the working memory 2.1 via the PCM switch 2.2 and the CPU 2.3.1. In this hardware embodiment of the telecommunications system the CPU 2.3.1 is utilized for the transport of digital sound sequences.

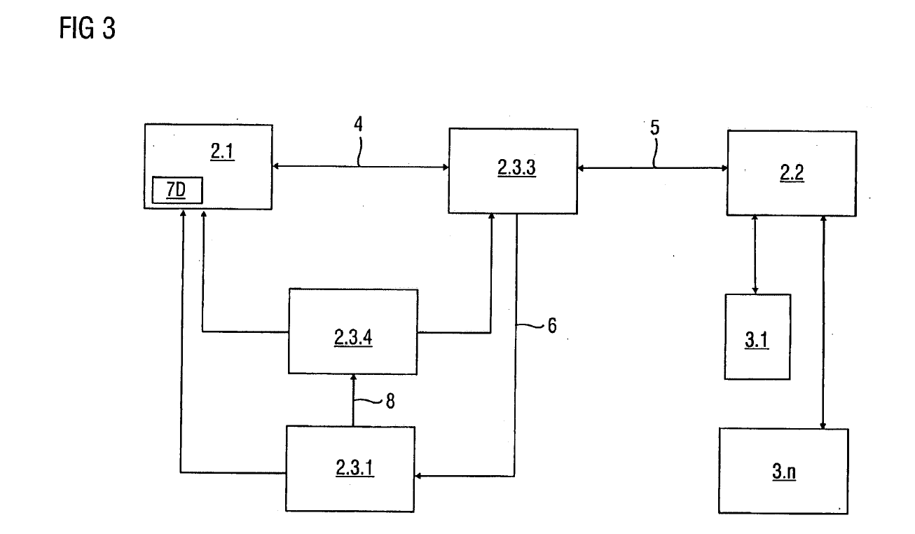

FIG. 3 shows in schematic form the new method for transmitting digitally stored sound sequences in a telecommunications system, wherein the data exchange is supported by a DMA controller. Digital sound sequences 7D are stored in the working memory 2.1, to which the CPU 2.3.1 has direct access, in addition to the program code of the telecommunications system. A timeslot assigner with FIFO shift register 2.3.3 is used between the PCM switch 2.2, which connects the terminals 3.1 to 3.n to the telecommunications system, and the working memory 2.1 of the telecommunications system. A DMA controller or PEC controller 2.3.4 is used between working memory 2.1 and TSA 2.3.3 to reduce the load on the CPU 2.3.1.

In order to output the sound sequences 7D stored in digital form in the working memory 2.1 to the terminals 3.1 to 3.n of the telecommunications subscribers, in the new method an output command 8 is issued to the DMA controller 2.3.4 by the CPU. The DMA controller 2.3.4 sets the start address of the digitally stored sound sequences 7D in the working memory 2.1 and the destination address in the FIFO shift register of the TSA 2.3.3. A data transfer 4 takes place between the working memory 2.1 and the FIFO shift register of the TSA 2.3.3. As soon as the FIFO shift register is half empty, the TSA 2.3.3 issues an interrupt command 6 to the CPU 2.3.1. The CPU 2.3.1 sends the DMA controller 2.3.4 a new output command 8, which sends the next data packet from the working memory 2.1 to the TSA 2.3.3. The load on the CPU 2.3.1 is reduced during the data transfer 4. The TSA 2.3.3 assigns the data to the terminals 3.1 to 3.n via the PCM switch.

In contrast, the new method with a PEC controller instead of a DMA controller is performed without the FIFO shift register of the TSA 2.3.3. The PEC controller (instead of 2.3.4) sets the start address of the digitally stored sound sequences 7d in the working memory 2.1 and the timeslot address as the destination address of the TSA 2.3.3. The individual samples of the sound sequence 7d are transmitted on an event-driven basis, where the event is the interrupt of the frame synchronization signal of the PCM switch 2.2. The PEC controller processes the events independently without the CPU, which merely issues the output command 8 at the start of the output.

All in all, therefore, there is presented by means of the invention a new method which uses a known telecommunications system or its existing hardware components in such a way that digitally stored sound sequences such as, for example, holding music (=MOH=Music on Hold), voice sequences or signal tones can be output and recorded without the need to use additional and expensive hardware components such as, for example, an SIU (Signaling Unit), a DSP (=Digital Signal Processor) or an AD/DA converter.

List of abbreviations and technical terms used:
AD converter Analog/Digital converter
CPU Central Processing Unit, central processor
DA converter Digital/Analog converter
DMA Direct Memory Access
DSP Digital Signal Processor
FIFO First In First Out
HDLC High Level Data Link Control
MOH Music on Hold
PBX Private Branch Exchange
PCM Pulse Code Modulation
PECC Peripheral Exchange Control
SIU Signaling Unit
Timeslot Programmed time period
TSA Timeslot Assigner, module that assigns data to programmed timeslots

1.-11. (canceled)

12. A method for handling digital sound sequences in a telecommunications system having a CPU, a working memory for the CPU, and a switching network, the method comprising:
establishing connections to a telecommunication terminal via the switching network by the telecommunications system;
outputting sound sequences via the switching network to the telecommunications terminal by the telecommunications system; and
using at least a part of the working memory to store the digital sound sequences.

13. The method as claimed in the preceding claim 12, wherein the CPU performs a data transfer of the digitally stored sound sequences between the working memory and switching network.

14. The method as claimed in the preceding claim 12, wherein data is transferred packet by packet and a time slot assigner (TSA) is used between the working memory and the switching to assign the digital sound sequences to programmed timeslots.

15. The method as claimed in the preceding claim 13, wherein data is transferred packet by packet and a time slot assigner (TSA) is used between the working memory and the switching to assign the digital sound sequences to programmed timeslots.

16. The method as claimed in the preceding claim 14, wherein a FIFO shift register is used in the time slot assigner (TSA) to support a packet-by-packet data transfer of the digital sound sequences.

17. The method as claimed in the preceding claim 15, wherein a FIFO shift register is used in the time slot assigner (TSA) to support a packet-by-packet data transfer of the digital sound sequences.

18. The method as claimed in the preceding claim 12, wherein in order to unload the CPU a microcontroller is used between the working memory and a time slot assigner (TSA), wherein the microcontroller is initialized by the CPU to perform the transfer of the digital sound sequences.

19. The method as claimed in the preceding claim 18, wherein the microcontroller is a Direct Memory Access (DMA) controller.

20. The method as claimed in the preceding claim 13, wherein in order to unload the CPU a microcontroller is used between the working memory and a time slot assigner (TSA), wherein the microcontroller is initialized by the CPU to perform the transfer of the digital sound sequences.

21. The method as claimed in the preceding claim 18, wherein the CPU requests the microcontroller to set the start address of the digital sound sequences in the working memory and to set the destination address in the FIFO shift register of the time slot assigner (TSA) in order to play back the digital sound sequences.

22. The method as claimed in the preceding claim 18, wherein the CPU requests the microcontroller to set the start address of the digital sound sequences in the FIFO shift register of the time slot assigner (TSA) and to set the destination address in the working memory for recording sound sequences.

23. The method as claimed in the preceding claim 21, wherein the CPU requests the microcontroller to set the start address of the digital sound sequences in the FIFO shift register of the time slot assigner (TSA) and to set the destination address in the working memory for recording sound sequences.

24. The method as claimed in the preceding claim 12, further comprising:
digitizing sound sequences and storing the digitized sound sequences in the working memory by the telecommunications system.

25. The method as claimed in the preceding claim 12, wherein at a certain filling level of the FIFO shift register, the time slot assigner (TSA) requests the CPU by an interrupt command to start or to stop a new data transfer.

26. The method as claimed in the preceding claim 12, wherein in order to unload the CPU a CPU with integrated Peripheral Exchange Control (PECC) transfer feature is used between the working memory and a time slot assigner (TSA).

27. The method as claimed in the preceding claim 12, wherein the digital sound sequences are MOH (=Music on Hold), voice sequences, or signal tones.

28. The method as claimed in the preceding claim 12, wherein program code and/or data of telecommunications subscribers being stored in the working memory.

29. A method for handling digitally stored sound sequences in a telecommunications system having a CPU, a working memory for the CPU, and a switching network, the method comprising:
setting up connections to telecommunications terminals via the switching network by the telecommunications system; and
outputting sound sequences via the switching network to at least one telecommunications terminal, wherein
at least a part of the working memory is used to store the digitally stored sound sequences.

30. A telecommunications system, comprising:
a CPU having a working memory; and
a switching network for connecting a terminal; and
mechanisms for performing the method as claimed in claim 12.

31. The telecommunications system according to claim 30, wherein the mechanisms
for performing the method as claimed in claim 12 are program mechanisms and/or program modules.
